(19) United States
(12) Patent Application Publication
(10) Pub. No.: US 2022/0351228 A1
(43) Pub. Date: Nov. 3, 2022

(54) System and method for generating, supplying and distributing digital assets using network based video games and reward applications.

(71) Applicant: Robert Alvarez, Los Angeles, CA (US)

(72) Inventor: Robert Alvarez, Los Angeles, CA (US)

(73) Assignee: Alvarez, CA (US)

(21) Appl. No.: 17/242,314

(22) Filed: Apr. 28, 2021

(51) Int. Cl. G06Q 30/02; A63F 13/792; A63F 13/352

(52) U.S. Cl. CPC G06Q 30/0209; A63F 13/792; A63F 13/352

(57) ABSTRACT

This document contains an invention denoted as a “virtual supply chain.” Its computerized systems and method generate, supply and distribute new assets including virtual rewards for video games and reward applications. Rewards and distribution take place over centralized and or blockchain networks. The “virtual supply chain” can be used to make new things possible using digital assets, such as video gaming as paid work.

### FIELD OF THE INVENTION

This invention is in the field of computerized assets, stored on databases centralized and/or decentralized on blockchain networks in ledgers and smart contracts. It also pertains to video games and distribution of virtual rewards.

### BACKGROUND

It is common practice in centralized video games such as console games to have inflationary supply of video games items and currency. Blockchain based gaming has promoted scarcer game item supplies and currencies, encouraged by the open market trading using blockchain and decentralized ledgers such as Ethereum and smart contract technologies. Commonly digital assets such as cryptocurrencies are created in “token pools”, with a common range of 10% of tokens going to team members, 30% going to a private sale, 30% in a public sale etc. These pie-splitting mechanics are how these assets are introduced to use-case ecosystems. They often include staking or deflationary economics. Challenges are faced in distributing assets fairly amongst old and new entities as gaming and blockchain economies grow.

### SUMMARY OF THE INVENTION

The invention is a system of generating supply of digital assets and distributing their ownership across computerized systems and centralized and/or blockchain networks. The types of digital assets are denoted as “seed packages,” “seeds,” “coins,” and “job tokens.” Users are given functions for generating and distributing new supply of these assets using on-demand systems.

The types are digital assets with individual IDs and the computerized system of the invention manages the distribution of new assets, rewards and ownership rights.

These assets and rewards are housed in application data, centralized and/or blockchain networks and used in functions across video games, computer applications and smart contracts. They can be transferred between wallets, applications and entities.

One skilled in the art will appreciate the advantage users leveraging supply with demand. As the economy grows a “virtual supply chain” can be leveraged by users. As demand for one digital assets grows, another asset in the chain can be created and owned to compete in the ecosystem where the user best finds opportunity.

### BRIEF DESCRIPTIONS OF THE DRAWINGS.

FIG. 1. Overview of digital asset system

FIG. 2. Overview of generation, issuance and ownership system.

FIG. 3. Flowchart illustrating examples of denoted “seed package” asset type functionality in a computerized system.

FIG. 4. Flowchart illustrating examples of denoted “seed” asset type functionality in a computerized system.

FIG. 5. Flowchart illustrating examples of denoted “job token” asset type functionality in a computerized system.

FIG. 6. Flowchart illustrating examples of denoted distribution of “coin” asset type functionality in a computerized system.

### DETAILED DESCRIPTION

Denoted as a “virtual supply chain” describes the invention's novelty in generating and distributing digital assets for rewards and video game systems. Its digital assets are denoted by four main types, “seed packages,” “seeds,” “coins,” and “job tokens.” To give a brief overview: “seed packages” create “seeds”, “seeds” create “coins,” and “coins” can be deposited into “job tokens” collaborating with reward systems for distribution. “Job token” type assets have the specific function of earning more rewards per a “coin” deposited and or tied to the asset.

These digital assets exist on computerized systems and/or centralized systems and/or blockchain based networks.

The reward systems for distribution and ownership are computerized and operated by centralized computer systems, servers and/or blockchain based networks.

“Ownership” henceforth describes the agency of the data by a user, server or decentralized system.

### Scenario 1

In the following scenario a user purchases and acquires ownership of a “seed package” from the system. This “seed package” has 10 “seeds” bonded to its ownership. One “seed” is deposited to the user's earning account and pays them one “coin” a day. The other “seeds” are placed in gaming pools for gamers to earn, each side distributing “coins” based on the reward systems amongst participating gamers. The purchaser described does not immediately benefit earnings from the “seeds” in the gaming pools. Instead, as more “seed packages” are purchased, the “seeds” in the gaming pools are slowly redistributed back to the original owner and into their earning account.

### Scenario 2

A “coin” can be used to create a “job token”. A “job token” can earn based on the amount of “coins” tied to said job token. The more “coins” tied, the more coins are earned from the distribution pool of rewards.

Referencing Scenario 1, a “job token” owner can earn based on their play time from the gaming pools seeded with coins.

Moreover, a “job token” owner can lend their “job token” to other gamers and share the revenue of digital assets rewarded from the rewards pool.

### Scenario 3

To prevent uneven distribution of rewards, “job tokens” can only have a maximum amount of coins deposited a week. This is called a “level cap” meaning a job token cannot be made powerful infinitely for rewards. Following scenarios 1 and 2, a user owning many “seed packages,” “seeds,” and “coins,” must create new “job tokens” since they cannot make more powerful job tokens. Since the owner can only use one job token at a time, they must share their many job tokens with many gamers and share revenue of the rewards. So and so forth this user will make more powerful “job tokens” but also create new “job tokens” to share with other players.

### DETAILED DESCRIPTIONS OF THE DRAWING

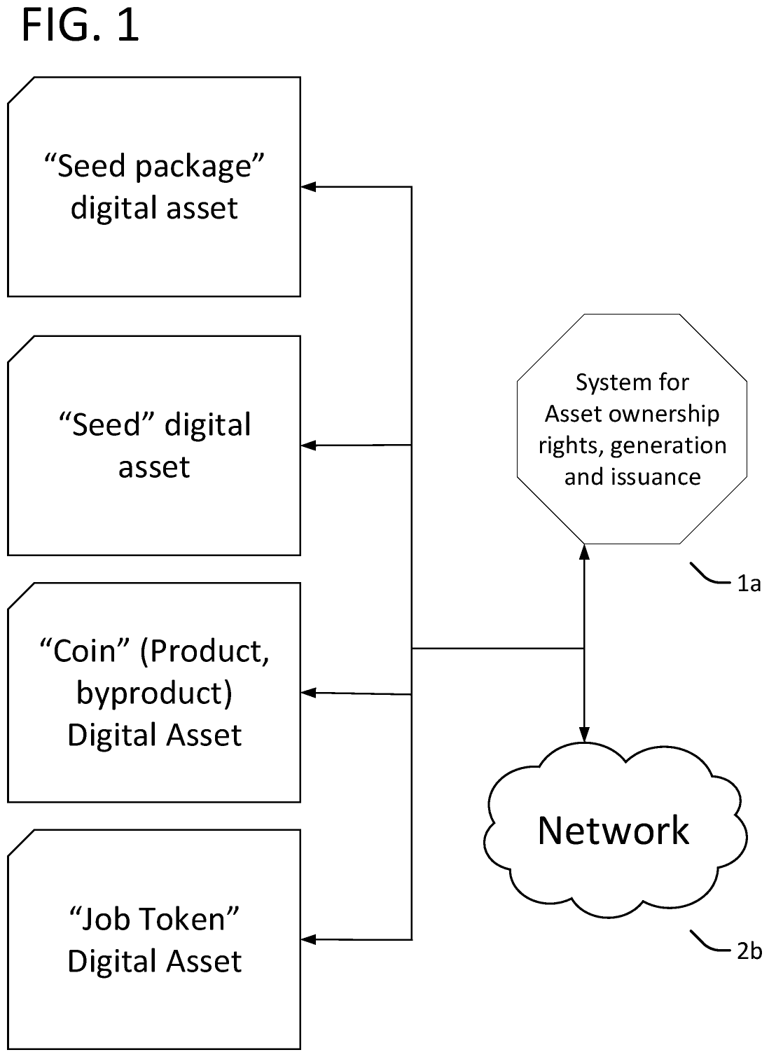

FIG. 1. Overview of “seed package,” “seed”, “coin,” and “job token” type digital assets stored and interacted with by a computerized system. Said digital assets are stored in memory, application data, centralized or/or blockchain network.

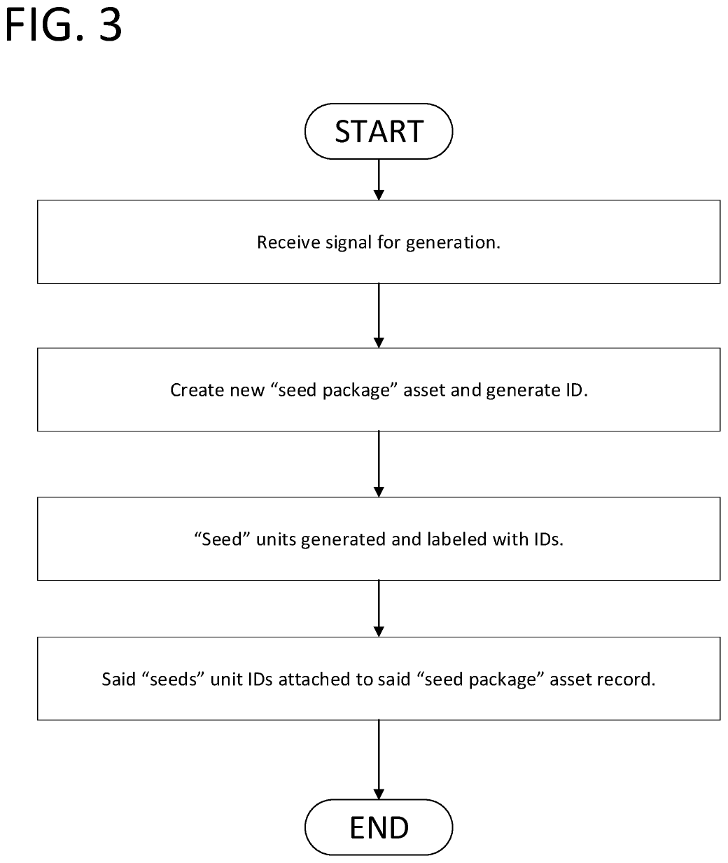

1a) System for asset ownership rights, generation and issuance. See drawing FIGS. 3, 4, 5, and 6 for flowchart examples of said system. See all scenarios 1-3 for functionality examples.

2b) Digital assets interact and/or stored by centralized and/or blockchain network, application data and/or smart contracts.

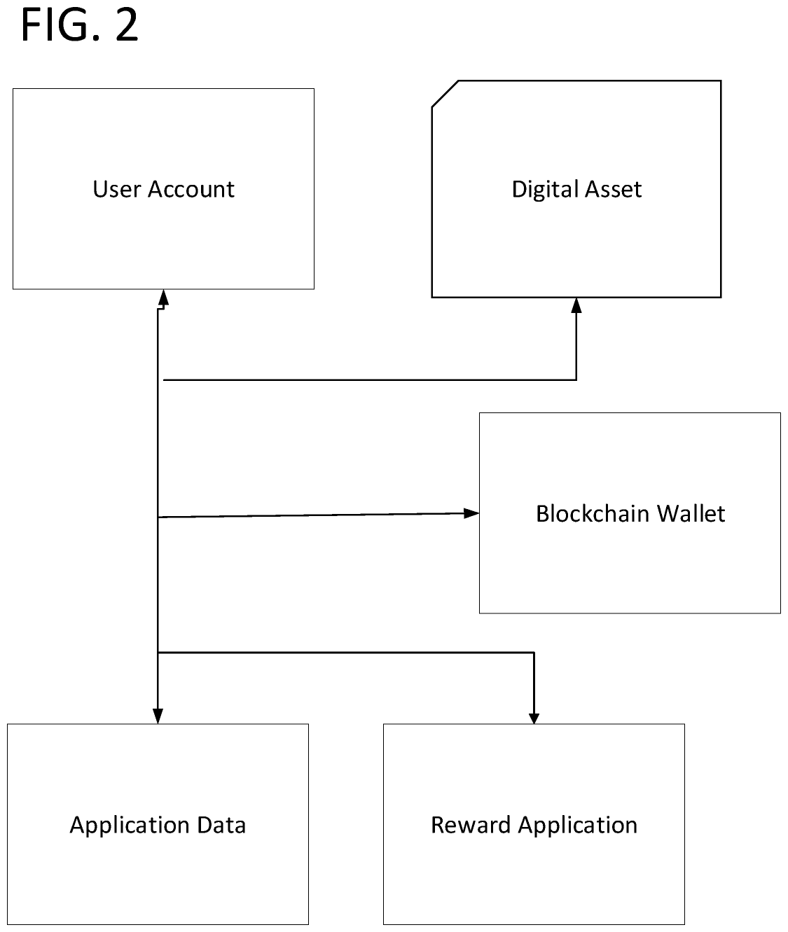

FIG. 2. Overview of generation, issuance, ownership, rights transfer of digital assets in a computerized system. Distribution and ownership of digital assets move between centralized server data and blockchain data applications and/or wallets. Reward applications include video games, active or passive based reward systems for distribution and ownership transfer. See drawing FIGS. 3, 4, 5, and 6 for flowchart examples of said system. See all scenarios 1-3 for functionality examples.

FIG. 3. Flowchart illustrating examples of denoted “seed package” asset type functionality in a computerized system. A data signal is received beginning computerized functionality. A new “seed package” asset is generated with an ID. “Seed” units are generated and labeled with IDs. Said “seeds” unit IDs attached to said “seed package” asset record.

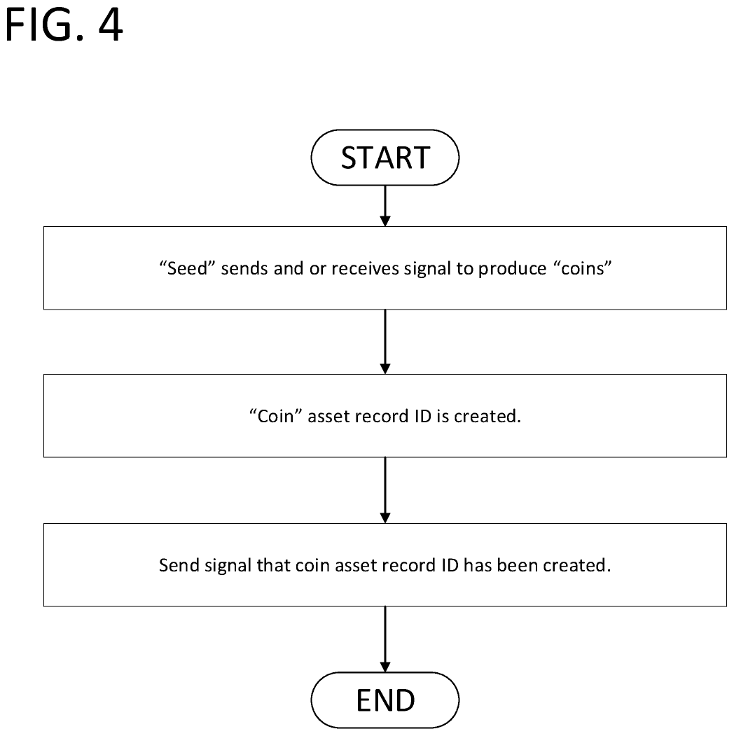

FIG. 4. Flowchart illustrating examples of denoted “seed” asset type functionality in a computerized system. Data signal is received beginning computerized functionality. “Coin” asset record ID is created and ownership determined.

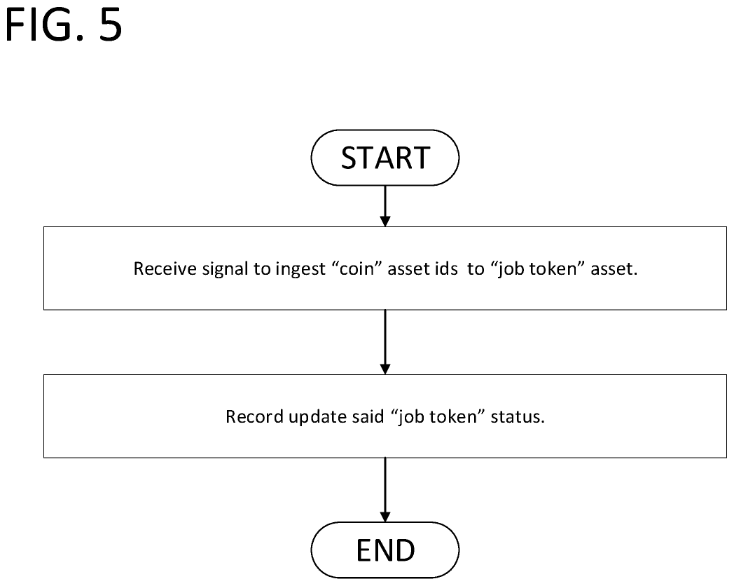

FIG. 5. Flowchart illustrating examples of denoted “job token” asset type functionality in a computerized system. A data signal is received to ingest “coins” into the “job token”. The job token status is updated.

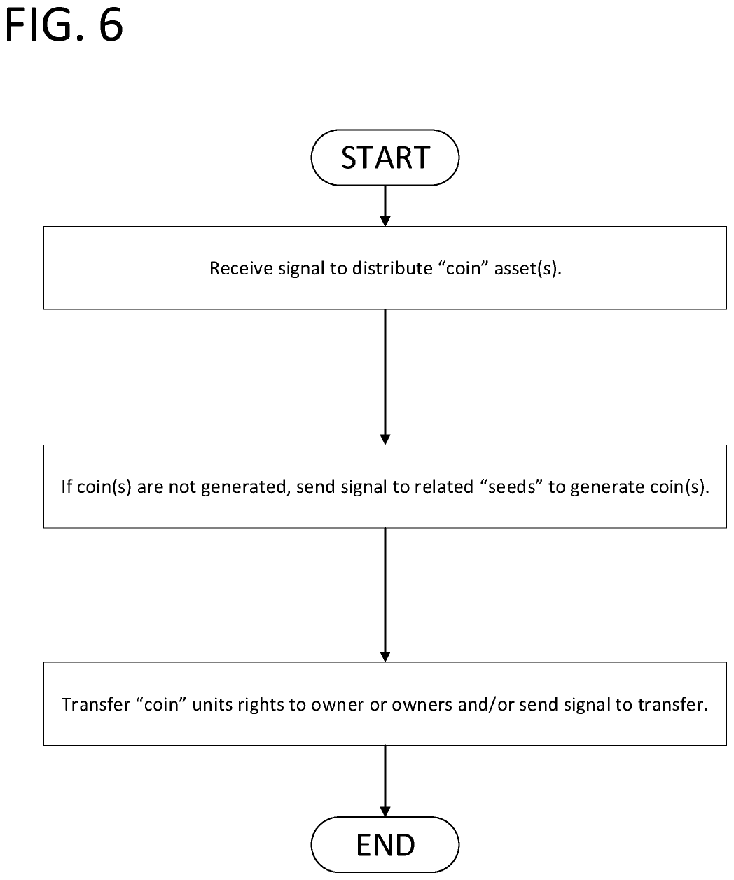

FIG. 6. Flowchart illustrating examples of denoted distribution of “coin” asset type functionality in a computerized system. A data signal is received to distribute “coin asset type. A plurality of “coin” in units are generated and/or sent to owners and/or rights assigned.

The invention claimed is:

1) A computerized system and method for generating, issuing and transferring ownership of digital assets in video games and reward systems via i) blockchain networks and ii) centralized networks.
The system comprises of:
a) A plurality of digital assets with methods and systems for generating and new digital assets.
b) Said digital assets tied to systems configuring distribution of said digital assets.
c) System for storing said digital assets on blockchain networks and centralized networks.
d) System for configuring and distributing rights of said digital assets.
e) System for storing rights of said digital assets and assets spawned from said asset.
f) Said digital asset for storing rights configured for distributing rewards of digital assets in claim 1.

2) The system of claim 1, a plurality of digital asset generating digital assets of new and or the same type. In the scenario of this documentation said digital asset generated on demand is denoted in this documentation as a “seed package.”

3) The system of claim 1, a plurality of digital asset generated and issued by the “seed package” asset. Said digital asset generated denoted in this documentation as a “seed” or “seed unit.”

4) The system of claim 1, a digital asset generated and issued by the “seed” denoted for this documentation as a “product,” “byproduct,” or “coin.”

5) The system of claim 1, a digital asset tied to the rights ownership and distribution of generated assets and reward systems. Denoted for this documentation as a “job token.”

6) The system of claim 1, where it is determined where rewards will be distributed.
